(19) United States
(12) Patent Application Publication
(10) Pub. No.: US 2021/0339460 A1
(43) Pub. Date: Nov. 4, 2021

(54) OPTICAL SHAPING APPARATUS

(71) Applicant: KANTATSU CO., LTD., Tokyo (JP)

(72) Inventors: Eiji OSHIMA, Tokyo (JP); Tomio KUSAKABE, Chiba (JP); Akira OSAKA, Chiba (JP); Hidekazu EBE, Chiba (JP); Kenichi TAKANASHI, Chiba (JP)

(21) Appl. No.: 17/373,512

(22) Filed: Jul. 12, 2021

Related U.S. Application Data
(63) Continuation of application No. 15/569,058, filed on Oct. 24, 2017, now abandoned.

(51) Int. Cl. B29C 64/106; B29C 67/00; B29C 64/25; B29C 64/264; B33Y 30/00; B29K 105/00; B33Y 40/00

(52) U.S. Cl. CPC B29C 64/106; B29C 67/00; B29C 64/25; B33Y 40/00; B33Y 30/00; B29K 2105/0058; B29C 64/264

(57) ABSTRACT

There is provided an optical shaping apparatus for readily implementing three-dimensional shaping with sufficiently high accuracy, including a material tank that has a bottom surface made of a light-transmitting material and accommodates a photo-curing liquid material, a light source unit that incorporates a driving mirror and scans the bottom surface with a laser beam, and a lifting mechanism that lifts a shaped object shaped by the laser beam from the material tank. The light source unit includes, as an optical engine, a housing, a laser diode that is arranged on one side in the housing and emits a laser beam, and the driving mirror that reflects reflected light from the laser diode by changing an angle in a vertical direction and a horizontal direction.

### TECHNICAL FIELD

The present invention relates to an optical shaping apparatus.

### BACKGROUND ART

In the above technical field, patent literature 1 discloses a three-dimensional optical shaping technique using Continuous Liquid Interface Production.

### CITATION LIST

### Patent Literature

Patent literature 1: US Patent Application Publication No. 2013/0292862A1

### SUMMARY OF THE INVENTION

### Technical Problem

In the technique described in the above literature, a large DLP projector 126 is used, as shown in FIG. 10, and it is thus impossible to readily implement three-dimensional shaping with sufficiently high accuracy.

The present invention enables to provide a technique of solving the above-described problem.

### Solution to Problem

One aspect of the present invention provides an optical shaping apparatus comprising:

a material tank that has a bottom surface made of a light-transmitting material and accommodates a photo-curing liquid material;

a light source unit that incorporates a driving mirror and scans the bottom surface with a laser beam; and

a lifting mechanism that lifts a shaped object shaped by the laser beam from the material tank,

wherein the light source unit includes, as an optical engine,

a housing,

a laser diode that is arranged on one side in the housing and emits a laser beam, and

the driving mirror that reflects reflected light from the laser diode by changing an angle in a vertical direction and a horizontal direction.

Another aspect of the present invention provides an optical shaping apparatus comprising:

a material tank that has a bottom surface made of a light-transmitting material and accommodates a photo-curing liquid material;

a stand that is used to install a smart device incorporating an optical engine for scanning the bottom surface with a laser beam; and

a lifting mechanism that lifts a shaped object shaped by the laser beam from the material tank.

### Advantageous Effects of Invention

According to the present invention, it is possible to readily implement three-dimensional shaping with sufficiently high accuracy.

### BRIEF DESCRIPTION OF DRAWINGS

FIG. 1 is a view showing the arrangement of a laminating and shaping apparatus according to the first example embodiment of the present invention;

FIG. 2A is a view showing the arrangement of an optical engine according to the first example embodiment of the present invention;

FIG. 2B is a view showing the arrangement of the optical engine according to the first example embodiment of the present invention;

FIG. 2C is a view showing the arrangement of the optical engine according to the first example embodiment of the present invention;

FIG. 3 is a view showing the arrangement of a laser projector according to the first example embodiment of the present invention;

FIG. 4 is a block diagram showing the arrangement of the laser projector according to the first example embodiment of the present invention;

FIG. 5 is a view showing the arrangement of the optical engine according to the first example embodiment of the present invention;

FIG. 6 is a view showing the arrangement of the housing of the optical engine according to the first example embodiment of the present invention;

FIG. 7 is a view showing a contrivance of the housing of the optical engine according to the first example embodiment of the present invention;

FIG. 8 is a view showing the contrivance of the housing of the optical engine according to the first example embodiment of the present invention;

FIG. 9 is a view showing the effect of the optical engine according to the first example embodiment of the present invention;

FIG. 10 is a view showing a smart device incorporating the laser projector according to the first example embodiment of the present invention;

FIG. 11 is a view showing the arrangement of a laminating and shaping apparatus according to the second example embodiment of the present invention; and

FIG. 12 is a view showing the arrangement of an optical engine according to the third example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

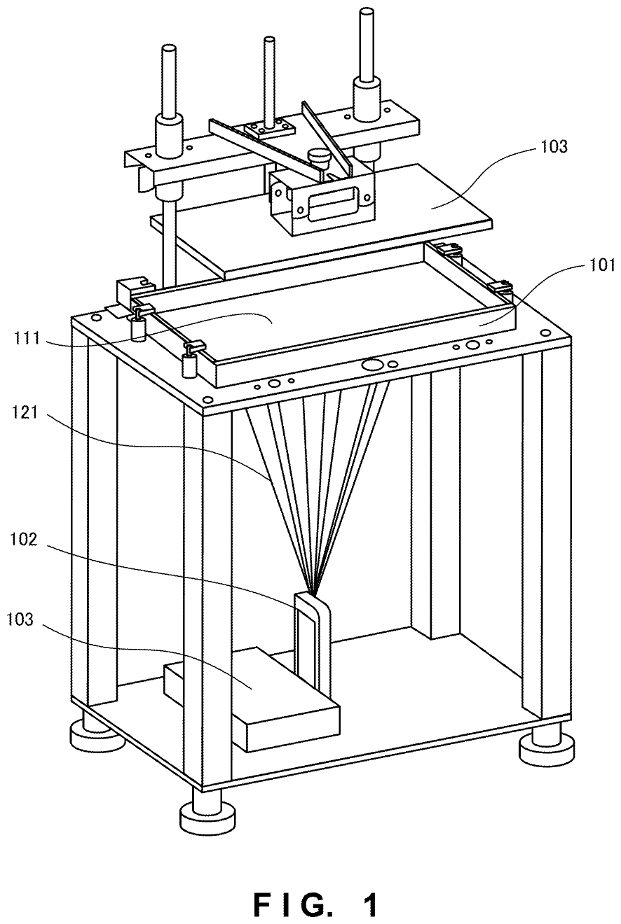

A laminating and shaping apparatus 100 according to the first example embodiment of the present invention will be described with reference to FIG. 1. The laminating and shaping apparatus 100 is a lift-type continuous liquid interface production shaping apparatus.

As shown in FIG. 1, the laminating and shaping apparatus 100 includes a material tank 101, a light source unit 102, and a lifting mechanism 103.

The material tank 101 is a material tank that has at least a bottom surface 111 made of a light-transmitting material and accommodates a photo-curing liquid material.

The light source unit 102 is a smart device incorporating a ultra-small laser projector, and scans the bottom surface 111 of the material tank 101 with a laser beam 121 from below.

The lifting mechanism 103 raises and lifts a shaped object shaped by the laser beam 121 from the material tank 101 in accordance with a laminating pitch.

An operation of performing curing by emitting the laser beam 121 from the lower surface of the material tank, raising a shaping table by one layer, and curing a sectional shape of the second layer under the shaping table is repeated, thereby sequentially laminating the layers, and performing shaping.

(Arrangement of Optical Engine)

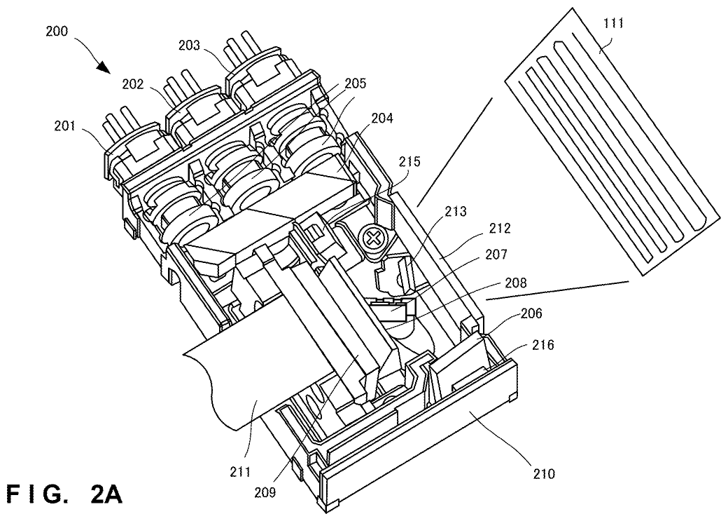

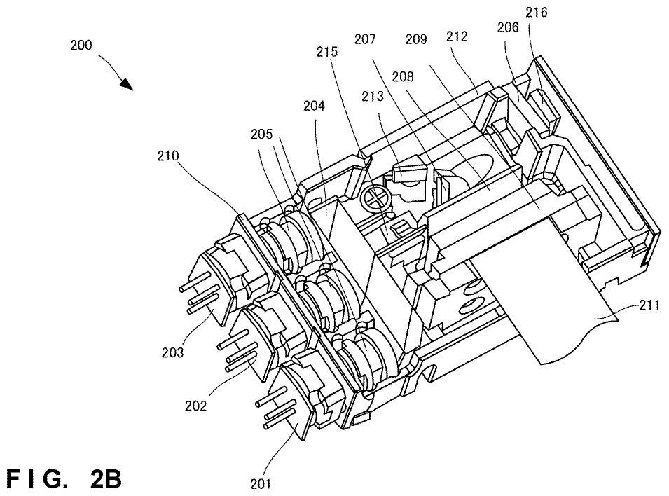

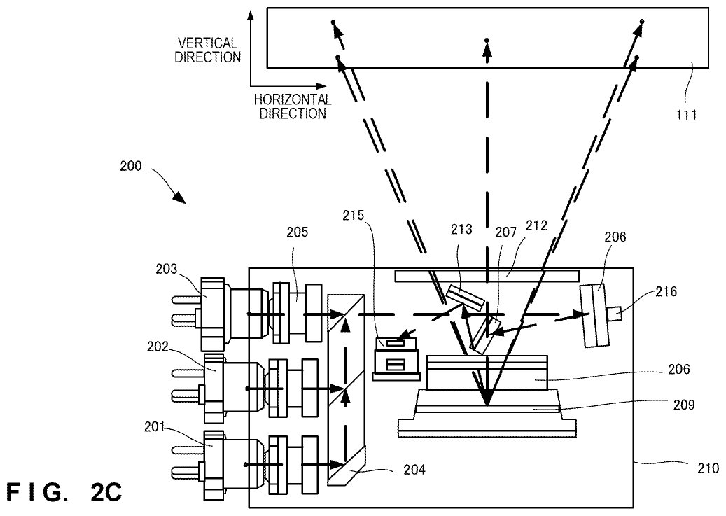

An optical engine 200 incorporated in the light source unit 102 will be described with reference to FIGS. 2A, 2B, and 2C. FIGS. 2A and 2B are perspective views respectively showing the internal arrangement of the optical engine 200 when viewed from different angles. FIG. 2C is a view showing an optical path in the optical engine 200.

The optical engine 200 includes, for example, laser diodes (semiconductor lasers) 201 to 203 of three colors of red light, infrared light, and ultraviolet light, and a prism mirror 204 for focusing light beams from the laser diodes 201 to 203 to obtain one light beam.

For example, the laser diode 201 emits ultraviolet light, the laser diode 202 also emits ultraviolet light, and the laser diode 203 emits infrared light. These laser diodes are arranged so that the laser diode with a shortest wavelength is farthest from a MEMS in order to equalize small errors in reflection angle or the like caused by a difference in wavelength.

The laser diodes 201 to 203 are arranged on one side of a housing 210 to face the inside of the housing 210. The prism mirror 204 reflects the two laser beams from the laser diodes 201 and 202 toward the laser diode 203 once. Then, the prism mirror 204 reflects again the two reflected light beams toward the inside of the housing 210 to be superimposed on the optical axis of the laser diode 203. The optical engine 200 includes collimator lenses 205 between the prism mirror 204 and the laser diodes 201 to 203, thereby adjusting the focal lengths of the laser beams to infinity.

An end portion of the housing 210 on the opposite side of the attachment surface of the laser diodes 201 to 203 is provided with an inclined mirror 206 inclining toward the bottom surface. The inclined mirror 206 reflects a laser light beam entering from the prism mirror 204 toward the bottom surface of the housing 210. Furthermore, a bottom mirror 207 is attached upward onto the bottom surface of the housing 210 between the prism mirror 204 and the inclined mirror 206. A two-dimensional MEMS mirror 209 and a cover glass 212 are provided to sandwich the bottom mirror 207. The bottom mirror 207 reflects, upward toward the two-dimensional MEMS mirror 209, the laser light beam entering from the inclined mirror 206. A prism 208 that determines an image projection elevation angle and size is provided at a position on the cover glass 212, which is adjacent to the two-dimensional MEMS mirror 209.

On the other hand, another bottom mirror 213 is provided between the bottom mirror 207 and the cover glass 212. A photosensor 215 is included between the prism mirror 204 and the prism 208. To calibrate the position of the MEMS mirror 209, the photosensor 215 notifies an external MEMS controller of the timing at which the light beam enters from the MEMS mirror 209 via the bottom mirror 213.

Furthermore, the inclined mirror 206 is a half mirror. A laser power sensor 216 is provided behind the inclined mirror 206, that is, in a gap between the wall portion of the housing 210 and the inclined mirror 206 to detect laser power and notify an external laser scan display controller of it.

With a scanning light beam that has been reflected by the MEMS mirror 209 and has passed through the prism 208 and the cover glass 212, a projected image is formed on the bottom surface 111.

As shown in FIG. 2C, the three light beams from the laser diodes 201 to 203 enter the prism mirror 204 via the collimator lenses 205, and are focused to obtain one light beam.

The light beam exiting from the prism mirror 204 is reflected by the inclined mirror 206 toward the bottom mirror 207. The bottom mirror 207 reflects upward the light entering from the inclined mirror 206, and the reflected light enters the central portion of the two-dimensional MEMS mirror 209 via the prism 208. The two-dimensional MEMS mirror 209 is a driving mirror that is driven based on an externally input control signal, and vibrates to reflect the light beam by changing an angle in the horizontal direction (X direction) and the vertical direction (Y direction).

(Overall Arrangement of Laser Pico Projector)

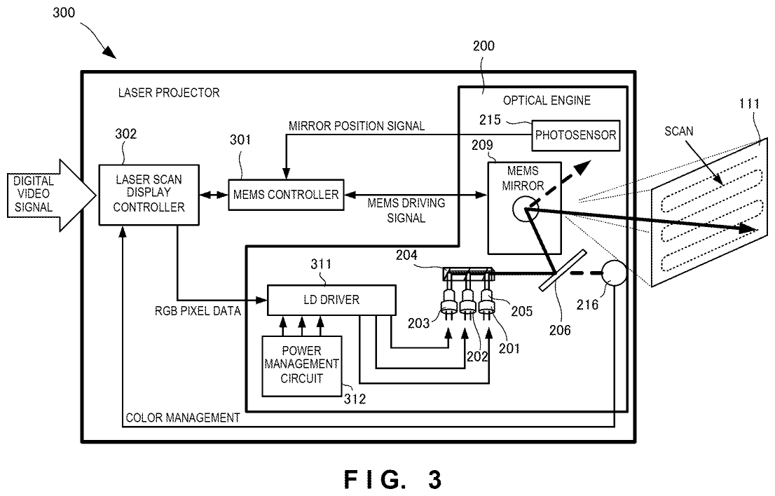

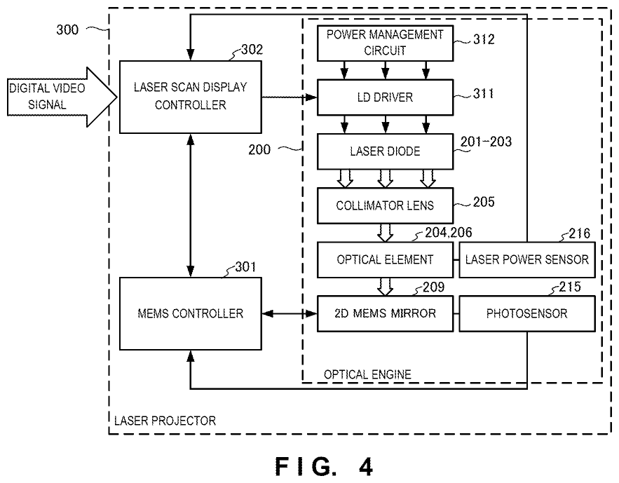

FIG. 3 is a view showing the arrangement of a laser projector 300 including the optical engine 200. FIG. 4 is a block diagram showing the functional arrangement of the laser projector 300. The optical engine 200 includes a laser diode (LD in FIGS. 3 and 4) driver 311 and power management circuits 312 in addition to the components described with reference to FIGS. 2A and 2B.

In addition to the optical engine 200, the laser projector 300 includes a MEMS controller 301 and a laser scan display controller 302.

If a digital video signal is externally input, the laser scan display controller 302 extracts a pixel count and a size, and transmits them to the MEMS controller 301. Furthermore, the laser scan display controller 302 decomposes the digital video signal into pixel data of respective colors, and sends the pixel data to the laser diode driver 311.

The power management circuits (PMCs) 312 control so the laser diode driver 311 does not erroneously operate during an initial transient period, for example, a rising period or falling period. Especially, during the transient period, an output voltage may be lower than a necessary voltage. The laser diode driver 311 may erroneously operate due to a low voltage and/or a fluctuation in voltage. To avoid this problem, the functional circuit block can be set in a reset state during the transient period.

The laser power sensor 216 detects power for each color of a laser transmitted through the inclined mirror 206, and feeds back power data to the laser scan display controller 302, thereby controlling the illuminances of the respective colors of the laser diodes 201 to 203.

FIG. 4 is a block diagram showing the functional arrangement of the light source unit 102 including the optical engine 200. The digital video signal input to the laser scan display controller 302 is modulated there, and sent to the laser diode driver 311. The laser diode driver 311 controls the luminance and irradiation timing of a laser projected by driving an LED of each color. The laser scan display controller 302 drives the MEMS controller 301 at the same time to vibrate the MEMS mirror 209 with respect to two axes under an optimum condition. The power management circuits 312 control the laser diode driver 311 to cause the laser diodes 201 to 203 to emit light beams at appropriate voltages at appropriate timings. The laser beam reflected by the two-dimensional MEMS mirror 209 via the collimator lenses 205 and optical systems 204 and 206 is projected on the bottom surface 111 as a shaping laser beam.

The above-described MEMS scan method provides light utilization efficiency much higher than that in DLP. Thus, the same shaping as that of DLP is possible with a laser of much lower power. That is, it is possible to reduce the cost and power consumption and decrease the size while achieving high accuracy. Furthermore, it is possible to narrow a laser beam (ϕ0.8 mm→ϕ0.02 mm), thereby improving the shaping accuracy.

Furthermore, it is possible to change a shaping area by changing the irradiation distance of the optical engine. The shaping area can also be changed by software without changing the irradiation distance of the optical engine. Therefore, it is possible to change the shaping area while keeping a lifting speed constant.

The total power of the laser diodes can be increased by changing the number of assembled laser diodes of the optical engine. For example, an output of 60 mW can be implemented using three laser diodes with an output of 20 mW. By assembling a plurality of laser diodes as light sources with the same wavelength, a high-output optical engine can be implemented.

By assembling a plurality of laser diodes that emit lasers of the same wavelength and different beam diameters, it becomes possible to select sharp/soft shaping in an arbitrary place.

By providing a plurality of laser diodes that emit lasers of different wavelengths, it becomes possible to select a wavelength optimum for a cured resin.

It is possible to mount two kinds of lasers of wavelengths corresponding to infrared light and ultraviolet light, and then perform automatic generation at a predetermined position with ultraviolet light while detecting a position with the infrared laser. The infrared laser serves as guide light.

Irradiation power can be changed for each irradiation dot. This can increase power of an edge portion having a sectional shape, or decrease the power to prevent penetration in inclined shaping or the like. Power control according to a shape is possible.

A shaping surface step can be changed by changing a spot diameter.

(Contrivance for Downsizing)

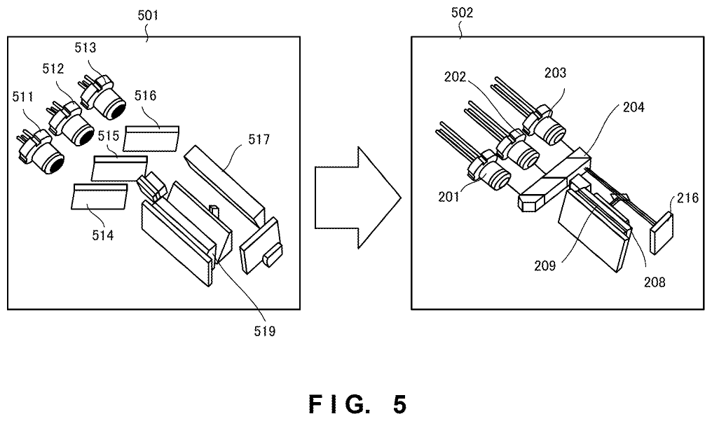

FIG. 5 is a view showing a contrivance in terms of the arrangement of optical systems in order to implement downsizing. As compared with an arrangement 501 according to a technical premise of this example embodiment, an arrangement 502 according to this example embodiment includes the following three contrivances to implement microminiaturization and improve the reliability and production efficiency.

(1) Instead of three laser diodes 511 to 513 spaced apart from each other, the small laser diodes 201 to 203 are arranged closer to each other.

(2) Instead of preparing reflecting mirrors 514 to 516 for the laser diodes 511 to 513, respectively, the one prism mirror 204 is arranged.

(3) A prism 517 provided to give an angle (elevation angle) to a projected video and suppress the influence of stray light is omitted, and the prism 208 that has been newly redesigned from a material to take countermeasures against stray light is provided.

Furthermore, in this example embodiment, as compared with the arrangement 501 according to the technical premise, the MEMS mirror 209 itself is small.

If a high-refractive index glass material used as the technical premise is adopted intact for the prism 208, the problem of stray light is not solved. Thus, a low-refractive index glass material is used. Then, countermeasures are taken against stray light not to influence a projected image by changing the angle of the prism 208.

(Contrivance to Improve Reliability and Productivity)

In the arrangement 501 according to the technical premise of this example embodiment, the laser diode 513 is adjusted for a target. Adjustment contents at this time include the position (two axial directions) of the mirror 516, the position (two axial directions) of a MEMS mirror 519, and a collimator lens (not shown) (five axial directions). Adjustment is performed by confirming that a laser beam spot of a predetermined size is formed at a predetermined position while the beam size falls within an adjustment range and reflected light from the hinge of the MEMS mirror 519 does not appear on a projected image, thereby adhering and fixing the collimator lens, the mirror 516, and the MEMS mirror 519 at appropriate points.

With respect to a light beam of another color, after completion of adjustment and adherence of the central laser diode, the collimator lens (five axial positions) is adjusted by targeting a position at a predetermined distance from the MEMS mirror 519.

At the time of adjustment of the central diode, an operation of executing adjustment of seven axes at the same time is performed, which requires an adjustment operation by a skilled engineer and takes a long time to perform adjustment. Precise optical axis adjustment has been performed by a skilled person using a man-machine system. In recent years, however, mass production at low cost is becoming very difficult due to a rise in labor cost, a shortage of skilled workers, and the like. Furthermore, since the collimator lens is adhered in a space, there is always a risk of shifting the adjusted beam position due to shrinkage of an adhesive caused by a change in environmental temperature, and thus the production efficiency and reliability are low. Especially, it is difficult to mount the arrangement on an on-board device or the like whose environmental condition is strict.

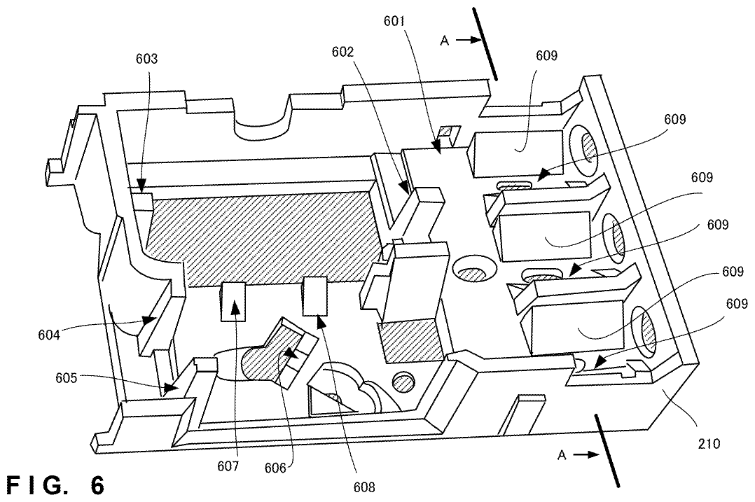

In this example embodiment, the housing 210, shown in FIG. 6, as a housing produced by die casting is used, optical parts except for the collimator lenses and laser diodes are abutted against the alignment unit of the housing 210 and adhered in advance. More specifically, the prism mirror 204 is brought into the corner of an alignment unit 601 and arranged. The MEMS mirror 209 is arranged to abut against alignment surfaces 602 and 603. In addition, the inclined mirror 206 is arranged to abut against alignment surfaces 604 and 605. Then, the bottom mirror 207 is adhered to an alignment surface 606. The prism 208 is adhered to abut against alignment surfaces 607 and 608.

This decreases adjustment points from the three parts of the arrangement 501 according to the technical premise to the two parts (the collimator lens 205 and the laser diodes 201 to 203). The housing 210 is an uncut and unprocessed housing, and thus the accuracy and production efficiency are very high, which is appropriate for mass production. Note that a molded part obtained using a mold of a resin or the like may be used as the housing 210.

Furthermore, at a position where each collimator lens (in fact, each collimator holder) is arranged in the housing 210, two inclined surfaces 609 for alignment, which have been molded with inclination, are prepared for each collimator holder.

(Collimator Holder Fixing Method)

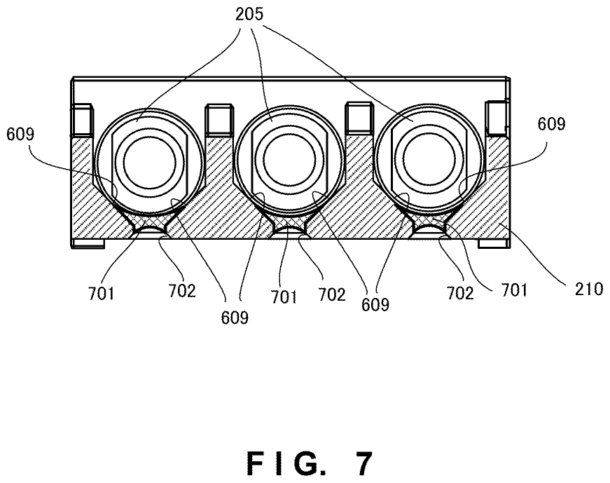

FIG. 7 is a view for explaining a collimator holder fixing method, and is a sectional view taken along a line A-A in FIG. 6.

In the technical premise, the laser diodes are press-fitted in the housing, the collimator holders to which the collimator lenses are adhered and fixed are optically arranged at appropriate positions by adjustment in a space above the housing, and a UV adhesive is poured into a portion between the housing and the collimator holders and cured by UV irradiation.

Since the adhesive shrinks in volume at the time of fixing by UV irradiation, there is the problem that the positions of the collimator holders change. Irradiation is performed by figuring out the irradiation amount and direction of UV light while monitoring a beam change direction when performing irradiation with UV irradiation light, thereby fixing the collimator holders at predetermined positions. Furthermore, in the projector, it is necessary to adjust the position of the green collimator holder and then match the blue and red beam positions with the green beam position, and thus the adjustment operation is extremely difficult. Even if adherence succeeds, the stress of the adhesive is relaxed in a QA test such as a thermal test, thereby posing the problem that the beam positions change.

In this example embodiment, the collimator lenses 205 (collimator holders) are abutted against the inclined surfaces 609 formed in the housing 210, thereby properly performing alignment. In this state, an adhesive 701 is injected from inlets 702 formed on the lower surface of the housing 210, and left for a predetermined time, thereby making it possible to firmly fix the collimator lenses 205 at the target positions. Instead of so-called adherence in a space, the parts are fixed in a state in which they are in direct contact with each other. Thus, no variation in position of each part caused by shrinkage of the adhesive occurs, and the stability and reliability are significantly improved.

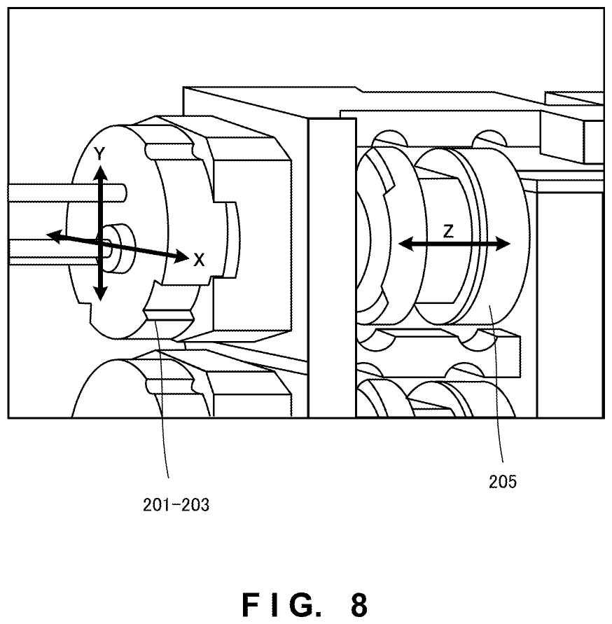

With respect to adjustment, as shown in FIG. 8, the laser diodes 201 to 203 (two axial positions along the X- and Y-axes) and the collimator lenses 205 (one axial position along the Z-axis) are used, and thus it is possible to reduce the number of axes from nine in the arrangement 501 according to the technical premise to three, thereby improving the production efficiency. That is, since a production system in which precise adjustment is integrated into an automatic operation that can be done by any skill-less operator is usable, and thus mass production is extremely easy.

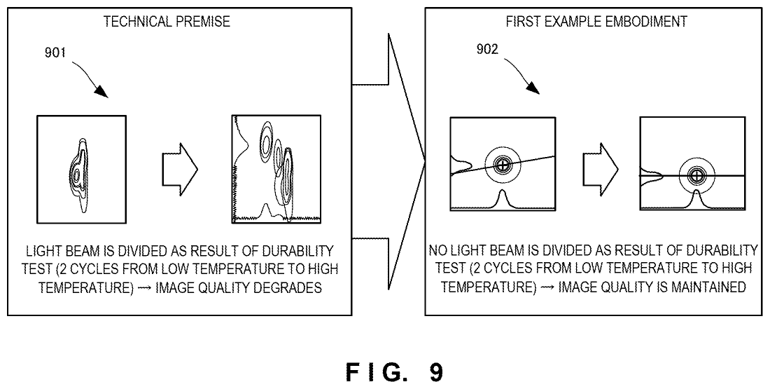

Furthermore, with the above-described arrangement, as a result, “the problem that the light beam is divided due to a thermal shock at high/low temperature” in an example 901 shown on the left side of FIG. 9 is solved, and a spot is adjusted to predetermined size and position, as in example 902 shown on the right side, thereby making it possible to significantly improve a variation in beam position.

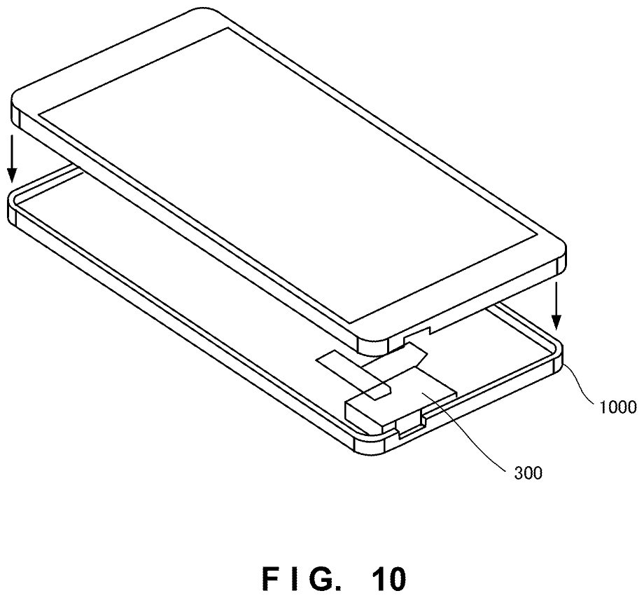

The laser projector 300 has been described above. Since the laser projector 300 is arranged to have a very small thickness, as described above, it can be implemented in a slim smart device 1000 shown in FIG. 10.

### Second Example Embodiment

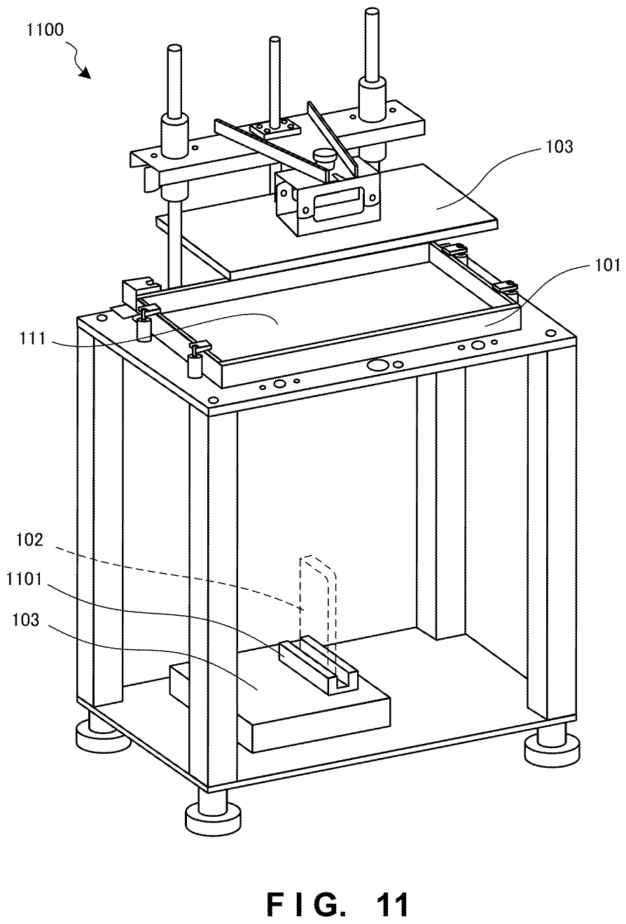

A laminating and shaping apparatus according to the second example embodiment of the present invention will be described next with reference to FIG. 11. FIG. 11 is a view for explaining the arrangement of the laminating and shaping apparatus according to this example embodiment. The laminating and shaping apparatus according to this example embodiment is different from that in the first example embodiment in that no light source unit is included. The remaining components and operations are the same as those in the first example embodiment. Hence, the same reference numerals denote the same components and operations, and a detailed description thereof will be omitted.

By using a smart device 1000 incorporating a laser projector, as shown in FIG. 10, it is possible to produce and sell a laminating and shaping apparatus 1100 including only a stand 1101 for the smart device instead of the light source, as shown in FIG. 11. If the user can arrange a 3D printer by only inserting his/her smart device into the stand 1101, the production efficiency of the laminating and shaping apparatus 1100 can be improved. As a result, it is possible to provide the 3D printer at low cost.

### Third Example Embodiment

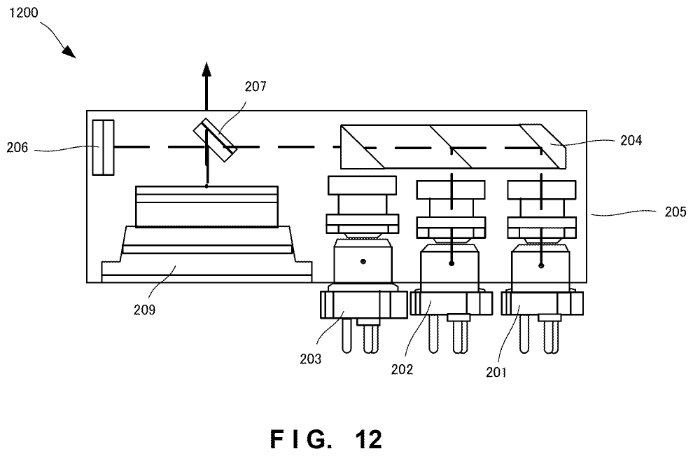

A laminating and shaping apparatus according to the third example embodiment of the present invention will be described next with reference to FIG. 12. FIG. 12 is a view for explaining the arrangement of an optical engine according to this example embodiment. The optical engine according to this example embodiment is different from that in the first example embodiment in that the optical engine includes neither the photosensor 215 nor the bottom mirror 213 and has a different arrangement of the remaining components. The remaining components and operations are the same as those in the first example embodiment. Hence, the same reference numerals denote the same components and operations, and a detailed description thereof will be omitted. By laying out the components, as shown in FIG. 12, it is possible to further downsize the apparatus while maintaining the image quality.

### OTHER EXAMPLE EMBODIMENTS

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

1. An optical shaping apparatus comprising:
a material tank that has a bottom surface made of a light-transmitting material and accommodates a photo-curing liquid material;
a light source unit that incorporates a driving mirror and scans the bottom surface with a laser beam; and
a lifting mechanism that lifts a shaped object shaped by the laser beam from said material tank,
wherein said light source unit includes, as an optical engine,
a housing,
a laser diode that is arranged on one side in said housing and emits a laser beam, and
the driving mirror that reflects reflected light from said laser diode by changing an angle in a vertical direction and a horizontal direction.

2. The optical shaping apparatus according to claim 1, wherein
said light source unit includes
at least a first laser diode and a second laser diode,
a prism mirror that reflects a laser beam from said first laser diode, and further reflects the laser beam in accordance with an optical axis of said second laser diode,
an inclined mirror that reflects a laser light beam entering from said prism mirror toward the bottom surface of said housing,
a bottom mirror that is provided on the bottom surface of said housing to reflect the reflected light from said inclined mirror upward, and
a driving mirror that reflects the reflected light from said bottom mirror by changing an angle in the vertical direction and the horizontal direction.

3. An optical shaping apparatus comprising:
a material tank that has a bottom surface made of a light-transmitting material and accommodates a photo-curing liquid material;
a stand that is used to install a smart device incorporating an optical engine for scanning the bottom surface with a laser beam; and
a lifting mechanism that lifts a shaped object shaped by the laser beam from said material tank.
